(19) United States
(12) Patent Application Publication
(10) Pub. No.: US 2021/0000096 A1
(43) Pub. Date: Jan. 7, 2021

(54) HOOK STORAGE APPARATUS

(71) Applicant: CHARLES HENRY MACDONALD, Willits, CA (US)

(72) Inventor: CHARLES HENRY MACDONALD, Willits, CA (US)

(21) Appl. No.: 16/504,122

(22) Filed: Jul. 5, 2019

(51) Int. Cl. A01K 97/06

(52) U.S. Cl. CPC A01K 97/06; A01K 83/00

(57) ABSTRACT

A hook storage container is provided comprising a housing including an inner volume, an upper end forming a dome having a diameter and a lower end, the lower end having a tubular shape and an opening into the inner volume. An opening is positioned at a center point of the dome having slots extending away from the center point, enabling insertion of a fishing hook and a collar having a diameter enabling secure placement around the dome.

### CROSS-REFERENCE TO RELATED DOCUMENTS

### Background of the Invention

### 1. Field of the Invention

The present invention is in the field of fishing equipment and accessories and pertains particularly to methods and apparatus for safely storing hooks.

### 2. Discussion of the State of the Art

In the art of fishing equipment and accessories, there has been much innovation in fish hook storage devices. The anatomy of a fish hook is ancient and generally involves at least one wire formed or ground to a point with or without a barb on one end and then bent near the point end to form a hook bend having a gape (distance between point and tine), and a throat or bite (elevation of point above hook bend). The hook generally has an eye formed on the end of the hook tine to attach a fishing line to or to attach to a lure body. Most manufactured hooks but not all include at least one hook barb point facing opposite the main hook point to prevent hooks slipping out of fish when they are hooked during fishing.

Hooks are manufactured in many sizes and varieties including small to very large single, double, and treble hooks manufactured for hooking different varieties and sizes of fish. Because hooks are sharp and barbed, and may cause injury to handlers, many companies and innovators have devised methods and apparatus to protect hook points from contact with the skin of a handler.

One classification relevant in the art is a hook guard, sometimes referred to in the art as a weed guide or weed guard. These types of hook protector devices are not designed with an intent to prevent inadvertent contact between the hook point or points and a handler. Weed guards are only intended to reduce the likelihood that the hook points will become lodged onto natural obstacles encountered while fishing such as weeds, snags, or similar underwater or surface water protrusions. A typical weed guard is a spring wire that may allow the hook points of the hook to be fully exposed in the event of a strike from a fish.

Another relevant classification of a hook protection device is a hook storage device. A hook storage device may be a tackle box that includes hook compartments, a soft plastic bag, a rubber or foam board, box lining, or material patch, or other containment apparatus that may guard the hook point from making contact with the skin of a handler until such time the hook is removed from the device for fishing. These devices use a variety of materials and methods to afford hook point protection including rubber, wood, foam, or plastic covering so the point remains hidden and protected until use. Still further, hooks attached to lure bodies are not typically protected in a device that would prevent the hook points from becoming exposed such as through soft body materials under repetitive pressures.

Some failings of current art devices exist in that the materials used are not resilient enough to prevent hook points from eventually protruding through the protective coverings obfuscating the intent of the device. Hook storage devices are often time carried in the user's pocket and must be durable. In other current art apparatus, the materials used are abrasive or hard and may eventually dull the hook points due to repetitive removal of the hooks from storage and replacement of the hooks back into storage. Prior-art failings exist in relation to methods devised for removing hooks from a storage device and replacing hooks into a storage device. A successful method for storing or removing a hook from storage depends, at least partially, on the apparatus design including utility and ergonomic considerations for ease of use.

Therefore, what is clearly needed is a hook storage apparatus and a method of use thereof that eliminates the failings in current art cited above, provides a “lockable” hook apparatus, wherein the hook is easily inserted and held securely, hands free, in an open position until closed and locked. Additionally, this easy to use design enables using the device in adverse conditions common to fishing including low light, wetness and unstable footing.

### BRIEF SUMMARY OF THE INVENTION

[TBD]

### BRIEF DESCRIPTION OF THE SEVERAL VIEWS OF THE DRAWINGS

FIG. 1 is an elevation view of a hook storage apparatus according to an embodiment of the present invention.

FIG. 2 is an overhead view of the hook storage apparatus of FIG. 1.

FIG. 3 is a section view of the hook storage apparatus of FIG. 2 taken along section line AA.

FIG. 4A is an elevation view of the hook storage apparatus of FIG. 1 with the collar urged upward to secure a hook.

FIG. 4B is an elevation view of the hook storage apparatus of FIG. 1 with the collar urged downward to release a hook for removal from storage or to prepare the body to accept a hook for storage.

FIG. 5A is a partial exploded view of a single hook bend with point contained in a single slot of the hook storage apparatus of FIG. 1 with the collar up and slot collapsed according to an embodiment of the invention.

FIG. 5B is a partial exploded view of the single hook bend with point contained in the single slot of the hook storage apparatus of FIG. 1 with the collar down and the slot expanded according to an embodiment of the invention.

### DETAILED DESCRIPTION OF THE INVENTION

In various embodiments described in enabling detail herein, the inventor provides a unique hook storage and protective apparatus. The present invention is described using the following examples, which may describe more than one relevant embodiment falling within the scope of the invention.

An object of the present invention is to provide a means for storing a variety of hook types and sizes in such manner as to preserve structural integrity of the hook including the state of sharpness of the hook. Another object of the invention is to safely store a hook whether or not the hook is loose, tied to a line, or part of a lure having one or more than one hook. The inventor provides a unique hook storage apparatus for utility storage of a single hook, a double hook, a treble hook, or a quadruple hook. The present invention is described in enabling detail using the following examples, which may describe more than one relevant embodiment falling within the scope of the present invention.

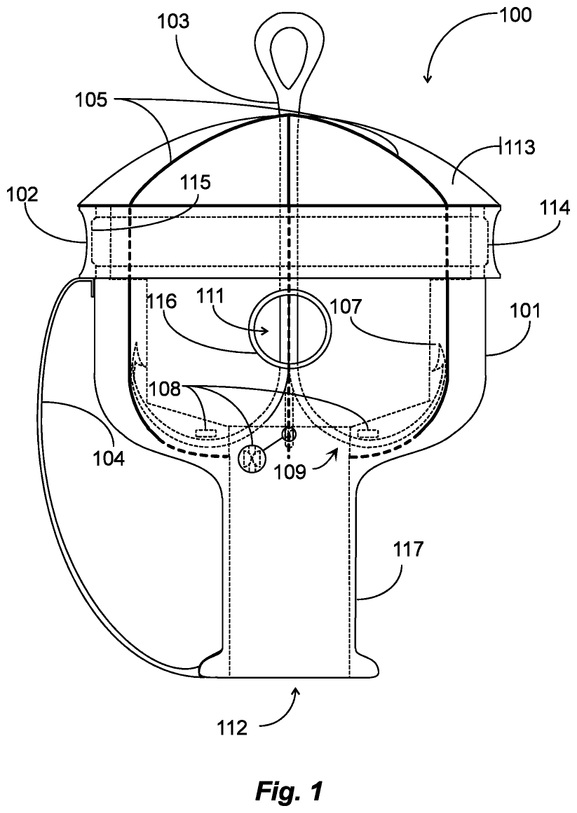

FIG. 1 is an elevation view of a hook storage apparatus 100 according to an embodiment of the present invention. Hook storage apparatus 100 includes a storage body 101. In one implementation, storage body 101 may be an annular body that is partially hollowed out having a dome surface 113 at one upper end and being open at the opposite lower end by virtue of a central bore opening 112. The outside diameter of dome surface 113 is significantly larger than the outside diameter of storage body 101 at the upper end thereof and may include a flat bottom surface facing down that is concentric with but exceeds the diameter of the storage body. Hook storage body 101 may be a body that is molded from a durable and resilient polymer that may also be resistive to ultra violet rays that can damage some hard plastic materials. In one embodiment, storage body 101 may be assembled from two annular parts fastened together without departing from the spirit and scope of the invention.

In this embodiment, storage body 101 is radially slotted through from the surface of dome 113 through the wall to a general depth. The slots are referenced herein as slots 105. Slots 105 terminate near the opposite end of body 101, thereby creating three equal partitions in the body. In this embodiment, there are three through slots 105 emanating from a center point or opening on dome 113. Slots 105 are angularly spaced apart at approximately 120 degrees radial separation, extending from bottom area 117. The body 101 may contain two or more slots provided through the dome or top surface of the body down through the wall of the body 101 to a point proximal to but not breaking out of the bottom end 117 of the device.

Hook storage body 101 has an open end designated by element number 112 that extends into a larger volume 111. Sufficient wall thickness is maintained in hook storage apparatus 100 to support the slots 105. When fully expanded, slots 105 are larger in gap than the diameter of a hook tine 109 of the hook being stored, thereby creating an opening allowing easy non-precise insertion of the hook 103. In this embodiment, the slots are tapered enabling guided entry for each tine 109 and each tine is co-axially aligned by opposing sides of each tapering slot as the tines are extended downward between two slot protrusions 108.

Storage body 101 may include openings or windows such as window 116 placed through the wall of the body 101 to allow for proper aeration or ventilation of the device to prevent moisture from condensing within the device rusting stored hooks. Hook storage body 101 is adapted by virtue of slots 105 set at 120 degrees radially to hold a treble hook 103 having three hook bends 109 radially set at 120 degrees apart. Treble hook 103 may be dropped down into expanded slots 105 in an upright position with hook points 107 pointing upward. Each hook tine 109 and hook point 107 occupies one of three slots 105. In an alternative embodiment, there may be two opposing slots formed in body 101 to accommodate two single tine hooks or even one slot for a single hook. Another embodiment provides 2 slots set at 90 degrees for double hooks.

A collar 102 is provided as a means to close or collapse slots 105 upon themselves. Collar 102 may be manufactured of a durable rigid polymer source material such as polymer or plastic tubing. Collar 102 is open with an inside diameter and a concave peripheral surface for ergonomic reasons, enabling a user's finger to grip. The inside diameter of collar 102 is just smaller than the outside diameter of storage body 101 at the upper portion thereof. In this embodiment, collar 102 includes a wide and relatively shallow radial groove 114 extending around the center of the ring on the inside wall. Groove 114 is designed to fit over an annular raised surface 115 formed about the outside diameter of storage body 101 near the top just beneath the bottom facing surface of the dome feature 113. In this manner, when the collar slides up it may snap into position.

Collar 102 may be integrally tethered, in this example, to storage body 101 via a thin flexible plastic strip 104 having an overall length, a width, and a thickness. Strip 104 may be integrally molded and applied to storage body 101 at a first lower connection point on body 101 via heat weld, tie, crimped cable or glue adhesive. In this way collar 102 may be kept with storage body 101 as a hook storage apparatus 100 when not in use storing a hook. In this embodiment, each slot 105 is a blind slot terminating at a same elevation near the bottom 117 of body 101 but not through the bottom area 117.

Hook storage apparatus 100 includes one or more slot protrusions 108, also referred to herein as slot protrusions. Slot protrusions 108 restrict the gap width of the slot 105 at a point in the slot coinciding with hook bend 109 such that even when the slot is unrestricted and open, the two parallel slot protrusions 108 form a gap just smaller than the diameter of hook tine 109. The diameter of a hook at hook tine 109 measured at the bend may be roughly equal to or just larger than the restricted width dimension of slot 105 between each slot protrusion 108 such that hook 103 may be initially inserted within the slot pattern down to and over the two slot protrusions 108 with the collar 102 in an open position (collar down). Once positioned around the storage body 101, collar 102 may be urged up over body 101 and raised surface 115, which in turn, fits into wide groove 114 to clamp or hold hook 103 in upright position (points 107 up) in the hook storage apparatus 100.

Slot protrusions 108 may occur on one or both partition surfaces forming each slot as formed protrusions or pads or other geometric land features. In one embodiment material may be added or welded into slot 105 and a second thinner slot may then be made to form the restricted dimension with control of tolerance to a specified machine standard. In another embodiment, slot protrusions 108 comprise material on both sides not slotted out in a first slotting operation and then slotted through to the restricted slot width dimension enabling the hook bends to pass a top slot protrusion and stop against a lower slot protrusion such that the hook bend may be contained between the individual upper and lower slot protrusions 108, at the bottom of hollow body 100. In this example, it may be assumed there are six slot protrusions (three opposing pairs) provided at 120 degree angular separations with one protrusion on one slot wall and the opposing protrusion on the opposing slot wall wherein the protruding protrusions are domed at the free end to enable the hook bend 109 to easily slide and pass by them, dropping in between the slots, when the slots 105 are expanded without collar 102.

In general use of the invention, a user may align, for example, a treble hook such as hook 103 with slots 105 and then may insert treble hook 103 into storage body 101 down to and just past the slot protrusions 108. The unrestricted width dimension of slot 105 is controlled dimensionally to enable hook 103 to be urged gently past the slot protrusions 108 at hook bend locations 109 with some friction or resistance when slots 105 are not under strain so the hook may snap down into the slot past the protrusions. The slots terminate just past that point leaving the hook bends to rest on the bottom of the slots.

Hook 103 may be thus retained somewhat secure or somewhat loosely in position between protrusions 108, within slots 105 with hook points 107 protected within the slot boundary from contact by any outside surface. In this position without the collar urged up against the bottom facing surface of dome end 113, hook 103 may be easily pulled out of retained position within slots 105 or urged into retained position within slots 105 with minimal friction between the hook material and the slot protrusions 108.

The user may, after positioning hook 103 within storage body 101, place collar 102 over the lower end of storage body 101 and urge the collar upward over the upper portion of the storage body 101 until groove feature 114 makes contact over the raised surface feature 115. The depth of groove 114 provides for measured closure of slots 105 to a clamped, collapsed or otherwise closed state that firmly retains hook 103 in stated position within hook storage apparatus 100 and prevents removal of the hook while collar 102 is in a clamped position on storage body 101. To remove a stored hook such as hook 103 from clamped hook storage apparatus 100, a user may, by pulling down on the collar, physically compress or deform the top portion of storage body 101 above the hook bends further to center sufficient to enable collar 102 to be physically dislodged from raised surface feature 114. The user may then slide collar 102 downward over the body to the bottom end of storage body 101 to release clamp force on the slots allowing them to expand to a non-tensioned state and then the user may physically urge hook 103 up and out of the body with little resistance.

In one embodiment of the invention, a through bore 112 extends vertically upward through the central axis of storage body 101 from the lower open end to where the upper portion of storage body 101 begins. At this point, bore 112 may open up in diameter to encompass more volume or space 111. In this case, the thicker wall dimension of hook storage body 101 equates to maximum slot surface coverage for hook bend 109 proximal to the lower section of the device with sufficient land in slot 105 to cover most of the hook bend 109 to and beyond the hook point 107, thus protecting the point from contact and damage. In one embodiment, hook storage body 101 contains four slots and can hold a four pronged hook. In another embodiment, a user may store a comparable sized single hook or tandem hook into hook storage apparatus 100 without departing from the spirit and scope of the present invention.

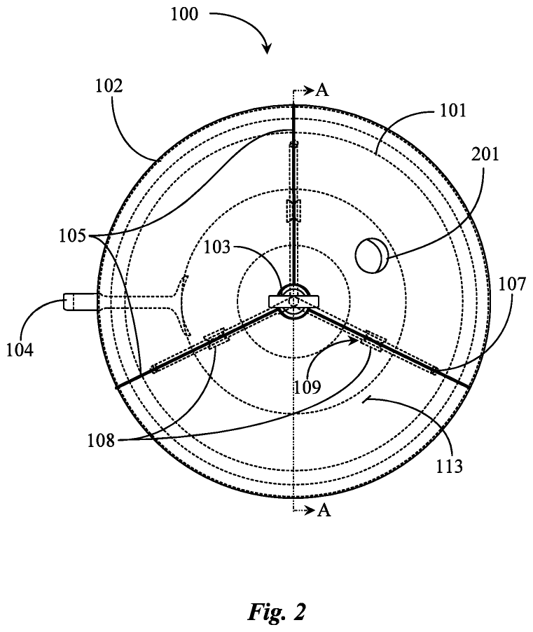

FIG. 2 is an overhead view of the hook storage apparatus 100 of FIG. 1. Hook storage apparatus 100 as viewed from the top depicts three slots 105 at clamped position via collar 102 depicted in hidden line and with plastic strip 104 attached. There may be more or fewer slots 105 provided in hook storage body 101 without departing from the spirit and scope of the present invention. However, there must be at least one slot 105 per hook bend 109 and hook point 107 of hook 103 in order to store a hook successfully. In this embodiment, a central opening is provided through the vertical center of dome feature 113 to accept the central tine portion of treble hook 103, which may vary in diameter depending on factors such as added tine weight for a hook tine.

The central opening must be large enough in diameter to accept the hook tine of hook 103. It is important to note herein that the central opening through which a hook may be inserted is not the primary clamping mechanism for stabilizing the hook. The hook is held in position at each hook bend 109 and the central opening is larger in diameter than the central tine or barrel portion of the hook.

The clamp width of slot 105 is depicted herein by solid two point line and is considered minimal such that the slot walls are adjacent to one another and may make contact. The unclamped slot width may be equal to or just greater than the diameter of the hook at hook bends 109. Upper slot protrusions 108 act to restrict slot width in a clamped position to prevent hook 103 from being physically removed from hook storage body 101. In a clamped state the opposing slot protrusions 108 make forced contact completely obstructing the passage out. In this way, hook 103 may be stabilized within apparatus 100 in a clamped state with collar 102 in place. Hook 103 may not be pulled out of the storage body 101 or be pushed further into the storage body 101 because of the lower slot termination points not visible in this view.

In one embodiment, aeration or vent openings 201 may be provided through dome surface 113 breaking out into the hollow space housing the central portion of hook 103 to prevent hook apparatus 100 from retaining water and becoming corroded. Similarly, openings might be provided at places through the vertical wall where they would not intersect one of slots 105. Hook storage apparatus 100 may be used to store loose fishing hooks such as inside a tackle box, preventing the hooks from getting entangled in fishing line or other fishing lures that may be carried within the tackle box. A user may carry hooks stored in this manner in pockets or soft bags without coming into skin contact with the hook points of those hooks. Furthermore, hooks tied to fishing line, and hooks attached to lures tied to a fishing line or stored loose may be protected using hook storage apparatus 100.

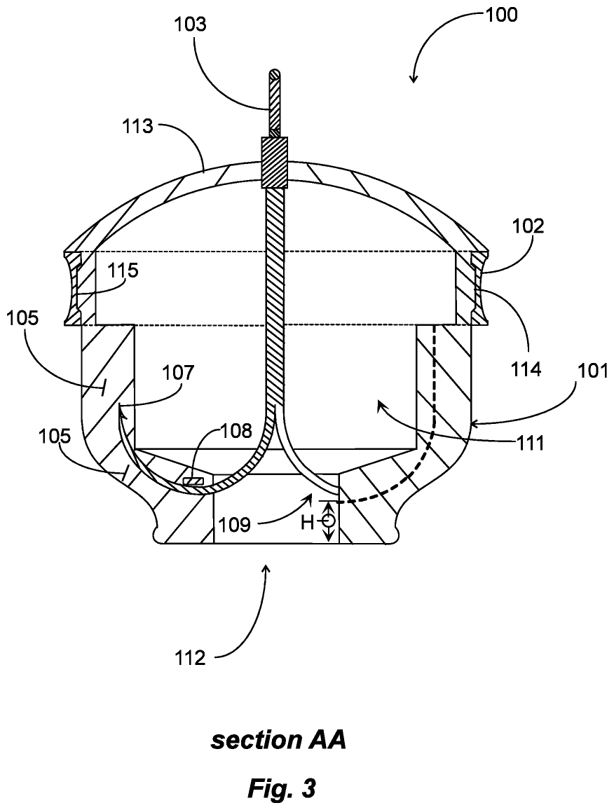

FIG. 3 is a sectioned view of the hook storage apparatus of FIG. 2 taken along section line AA. Hook storage apparatus 100 is depicted herein according to section line AA showing solid sectioned surface material of slot 105, hook 103 and, in contrast, the open space 112 and 111 within storage body 101. In this view, collar 102 is in clamped position over storage body 101, specifically interfacing at raised surface feature 115 on body 101 and wide groove 114 on the inside of collar 102.

In section AA, slot surface 105 extends from the top center of storage body 101 down to a slot termination point just below the hook bend 109. The elevation of the slot termination point is referenced herein as H from the bottom end of body 101 to the slot termination point represented by dotted line. An opening at top center through dome feature 113 is sufficient in diameter to accept the wider portion of the hook tine of hook 103 at center so the hook 103 may be inserted fully into the storage body 101 at a sufficient depth to breach the slot protrusions 108 as shown herein with the slot protrusions just above the hook bend 109 about mid gape.

In this sectioned view, the right side of body 101 depicts a slotted surface representing the solid wall material of storage body 101 from the bottom to the top center point of dome 113 and the slotted body of collar 102, which is also so represented on the opposite side of this view. The parts of hook 103 depicting a cut surface in line with section line AA includes the hook eye, the central hook tine or barrel and the hook bend on the left side of the view. In this embodiment, collar 102 has a central wide groove 114 that may be urged over and onto raised surface feature 115 in order to prevent collar 102 from inadvertently slipping down.

In another embodiment, there may be a different pair of features provided to secure collar 102 in place at the top of hook storage body 101. For example, an angled surface feature may be provided around storage body 101 whereby the top portion of the angled surface feature represents the largest outside diameter of the storage body 101. A mating angular groove may be provided about the inside of collar 102 whereby a rim feature at the top inside surface of the collar may locate and catch onto the raised edge of the angular raised feature on storage body 101 to prevent collar 102 from slipping down.

In one embodiment of the present invention, storage body 101 may include a bridge or lateral rim of material near the top of opening 112 that may provide a down stop for hook 103 at a position below the hook bends 109. In this example, slots 105 terminate just below slot protrusions 108 providing a solid stop for each prong of hook 103. In still a further embodiment, hollow space above the middle are of storage body 101 may be purposely limited thereby presenting more solid wall in storage body 101 material for increasing the foot print of slot 105 further up from the middle section to store hooks having shorter hook tine than hook 103 and a comparable hook size.

Storage body 101 is slotted down to near bottom and exhibits a resilient spring factor in the material enabling a user to physically grip the base 117 and slide the collar up, snapping the collar into position, thereby closing the slots 105, or sliding the collar down to be adjacent to base 117 enabling the slots to open. Slots 105 expand back to an uncompressed state without collar 102 and are then at their widest in dimension. A characteristic of the material used to mold hook protection apparatus 100 is resiliency and semi-rigid nature making the slot conformative in gripping a hook bend where the slot protrusions may compress together to completely block the slot preventing pull out of the hook. The slots may be compressed together such that the slot walls make contact. However, hooks of a same tine length and gape may vary according to wire thickness from fine to heavy gauge wire. Therefore, nominal slot width W may vary accordingly.

It is noted herein that hook storage apparatus 100 may be manufactured in different size ranges in order to accommodate different sizes of fishing hooks ranging from very small freshwater hooks up to the larger saltwater hooks where practical. One hook storage apparatus 100 may accommodate a specific size range of hooks. Overall diameter, overall length, and nominal slot width may vary according to the size range of hooks the apparatus is manufactured to store. There are many possibilities. While the storage body size will change significantly for different sized hooks, the handle/base 117 will remain a size that is comfortable for a user to grip. As such, the proportion between the size/diameter of the storage body 100 and the handle or base 117 will vary.

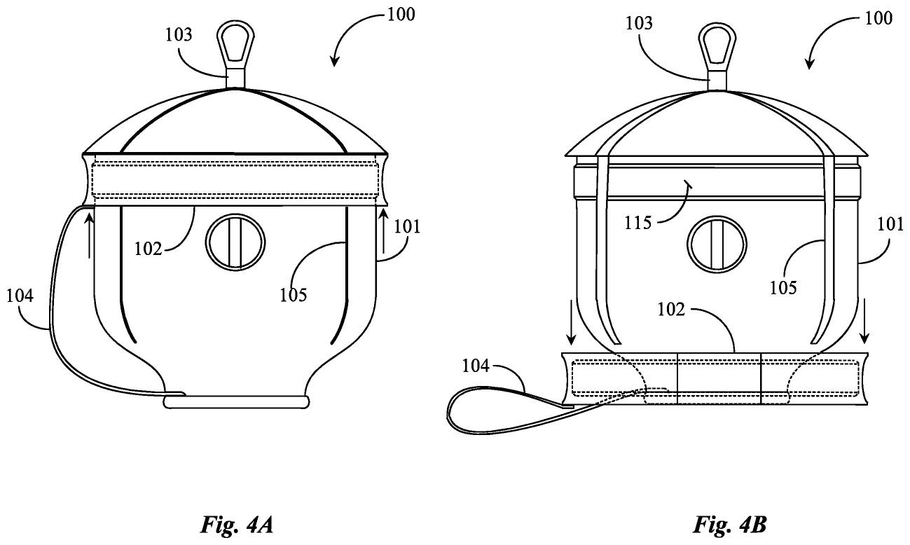

FIG. 4A is an elevation view of hook storage apparatus 100 of FIG. 1 with the collar urged upward to secure a hook. FIG. 4B is an elevation view of hook storage apparatus 100 of FIG. 1 with the collar urged downward to release a hook for removal from storage or to prepare the body to accept a hook for storage. Referring now to FIG. 4A, hook storage apparatus 100 is depicted in a clamped position with collar 102 urged upward over storage body 101 according to the direction of the arrows. At this point, collar 102 is secured in clamp position by mating physical features such as a raised land area 115 provided around storage body 101 and a wide shallow groove 114 provided around the inside of collar 102.

In one embodiment, raised surface ring 115 may be provided in shorter sections around storage body 101 and groove 114 may be like designed providing indentations that fit over the raised sections. In such an embodiment, a user may have to align collar 102 with respect to the placement of the indentations 114 present on the inside of collar 102 and the raised sections 115 present on the storage body. Other geometric mating features might be provided to enable nesting and securing collar 102 over storage body 101 in the clamped position without departing from the spirit and scope of the present invention.

In clamped state as depicted in FIG. 4A, the hook storage apparatus 100 firmly holds the hook in position within the slots, which are closed by collar 102. Referring now to FIG. 4B, hook storage apparatus 100 is depicted in an unclamped state with collar 102 displaced from raised land feature 115 and urged down over hook storage body 101 according to the direction of the arrows. In this unclamped position, the slot is at the widest dimension. In this unclamped state, a user may pull a hook from storage body 101, or may place a hook into storage body 101 as afforded by the unclamped slots. It may also be noted herein that in an unclamped state, the slot protrusion features 108 described further above may still prevent the hook from falling out of or slipping further into storage body 101 of its own accord. This is because the dimension between the domed opposing ends of slot protrusions 108 is smaller than the diameter of the hook at hook bend 109. The resiliency of the material and the semi-rigid properties of the body material enable the slots to form and flex and the slot protrusion to be compressed completely together to fully obstruct the hook from being retrieved from the apparatus.

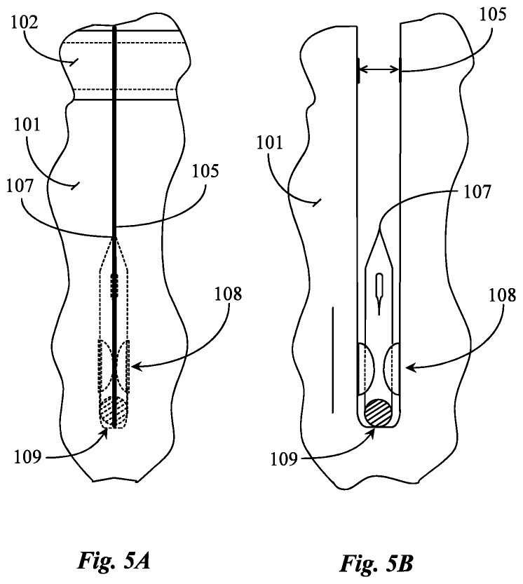

FIG. 5A is a partial exploded view of a single hook bend 109 with point 107 contained in a single slot 105 of the hook storage apparatus 100 of FIG. 1 with the collar 102 up and slot 105 collapsed according to an embodiment of the invention. In this view collar 102 is in clamped position and slot 105 is closed over hook bend 109 and the slot encompassing hook point 107 protecting the point from moisture and from any kind of contact with an abrasive material. In this exploded view, slot protrusions 108 are a pair of opposing protrusions that are domed on the free ends to allow easy but frictional resistive travel of the hook bend down in slot 105 past the protrusions when the slot is expanded with collar 102 off as depicted in FIG. 5B. With collar 102 in place as depicted in FIG. 5A, slot protrusions 108 may be compressed tightly together to form a complete slot protrusion.

FIG. 5B is a partial exploded view of the single hook bend 109 with point 107 contained in the single slot 105 of the hook storage apparatus of FIG. 5B with the collar 102 removed and the slot expanded according to an embodiment of the invention. In this exploded view slot 105 has a gap referenced herein by the double arrows bracketed and associated with element number 105 for the slot. With slot 105 expanded, slot protrusions 108 may collectively take up more slot space than hook bend 109 and may still prevent hook bend 109 from being too easily pulled from the apparatus. Rather, in an expanded state, the slot protrusions 108 provide a frictional resistance to the hook bend passing through the slot past the protrusions.

A user may push the hook down into the hook storage apparatus and when the hook bends come in contact with the slot protrusions, the user may exert a slight force to snap the hook bends down past the protrusions and against the terminated slot bottoms. Slipping collar 102 back up to and against the dome results in clamping the slots together and forcing the hook in position against the slot bottoms past the slot protrusions. In this state the hook may not be removed from hook storage apparatus 100 without first unclasping collar 102 from the top of the device.

It will be apparent to one with skill in the art that the hook storage apparatus of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention. The invention is limited only by the breadth of the claims below.

1. A hook storage container, comprising;
a housing having an inner volume, an upper end forming a dome having a diameter and a lower end, the lower end having a tubular shape and an opening into the inner volume;
an opening at a center point of the dome having one or more slots extending away from the center point, enabling insertion of a fishing hook; and
a collar having a diameter enabling secure placement around the dome;
wherein, insertion through the opening of the hook includes at least one hook tine moving through the at least one slot where the tine bends, a main shaft of the hook passing through the opening, and placement of the collar around the lower end enables the hook to be inserted through the opening and the one or more slots and with the collar placed around the dome, closes the one or more slots thereby securing the at least one tine of the fishing hook within the housing after insertion.

2. The container of claim 1, wherein there are three equidistantly spaced slots extending away from the opening towards the lower end, thereby dividing the dome into 3 equal portions and the fishing hook is a treble hook.

3. The container of claim 1 wherein a diameter of the lower end is less than the diameter of the dome and the dome includes a recess enabled to accept the collar within the recess.

4. The container of claim 1, wherein a tether is provided connecting the collar to the lower end.

5. The container of claim 1, wherein the lower end is of a length enabling a user to grasp it while inserting the fishing hook.

6. The container of claim 1, wherein two protrusions are positioned at a point where the lower end meets the dome within the container enabling insertion of the at least one tine to be held securely between the two protrusions when the collar is at a position around the lower end.

7. The container of claim 6, wherein two protrusions are aligned with each slot at a point where the lower end meets the dome within the container enabling securing each tine of a treble fishing hook within the container.

8. The container of claim 3, wherein the collar includes a second recess enabling grip of a user and wherein the second recess rests within the recess of the dome when in position around the dome.
